(19) United States
(12) Patent Application Publication
(10) Pub. No.: US 2010/0123536 A1
(43) Pub. Date: May 20, 2010

(54) TUNABLE CAPACITIVELY LOADED TRANSFORMER PROVIDING SWITCHED INDUCTANCE FOR RF/MICROWAVE INTEGRATED CIRCUITS

(76) Inventors: Yumin Lu, Chelmsford, MA (US); Ian Gresham, Somerville, MA (US)

Correspondence Address: AUTOLIV ASP INC, 3350 AIRPORT ROAD, OGDEN, UT, 84405, US

(21) Appl. No.: 12/274,110

(22) Filed: Nov. 19, 2008

(51) Int. Cl. H01F 17/00

(52) U.S. Cl. 336/105

(57) ABSTRACT

A tunable transformer providing switched inductance includes a primary winding and a secondary winding. A switch is connected to the secondary winding of the transformer. At least one capacitor is also connected to the secondary winding of the transformer with the switch.

### BACKGROUND OF THE INVENTION

This invention relates generally to inductance tuning, and more particularly, to switched-inductance tuning.

Inductance tuning may be used in many different applications, such as to provide frequency tuning in microwave communications. For example, a magnetically-coupled tunable inductor for variable frequency oscillators may be used to tune the frequency of a voltage controlled oscillator (VCO) within radio-frequency (RF) communication devices, such as switching between different frequency bands in a multi-band or multi-mode wireless transceiver. For a fully integrated VCO a tunable LC resonator may be provided as part of an RF integrated circuit to improve performance of a communication device using magnetically coupled inductance tuning. The VCO then operates to provide, for example, frequency translation based on the tuning of the VCO. Accordingly, fine tuning at different frequency bands is important for proper communication.

Conventional inductance tuning methods include using active inductors where the inductors are tuned using amplifiers with feedback. Other conventional inductance tuning methods include biasing transistors to present a positive reactance to a circuit. At microwave frequencies, the small sizes of the devices providing the inductive tuning makes the conventional methods very sensitive to variations, for example, in the manufacturing process. Moreover, the requirement for direct current (DC) bias is inefficient and is also the source of high-noise injection to the circuit, thereby degrading performance. Accordingly, these conventional inductance tuning methods are suitable for low-frequency applications, but typically not for higher frequency VCO applications.

For higher frequency VCO applications, a switched inductor arrangement is typically used. The inductors may be connected in series or parallel and switches are used to short one or more of the inductors to achieve inductance tuning. These switched arrangements can result in wasteful or inefficient use of circuit area and can make circuit layout difficult. Additionally, it can be difficult to make small or incremental changes to the inductors reactance.

### BRIEF DESCRIPTION OF THE INVENTION

In accordance with an exemplary embodiment, a tunable inductor is provided that includes a transformer having a primary winding and a secondary winding and a switch connected to the secondary winding of the transformer. The transformer is capacitively loaded with at least one capacitor connected to the secondary winding of the transformer with the switch.

In accordance with another exemplary embodiment, a tunable transformer is provided that includes a primary coil having a self-inductance L1. The tunable transformer further includes a secondary coil having a self-inductance L2. An effective inductance is defined by the inductance on the primary coil with the secondary coil loaded with the combination of a capacitor and a switch.

In accordance with yet another exemplary embodiment, a method of tuning a transformer using capacitive loading is provided. The method includes connecting at least one capacitor to a secondary winding of the transformer and providing a switch to connect and disconnect the at least one capacitor from the secondary winding of the transformer to provide a switched inductance.

### BRIEF DESCRIPTION OF THE DRAWINGS

FIG. 1 is a drawing illustrating a tunable inductor constructed in accordance with various embodiments of the invention.

FIG. 2 is schematic representation of a tunable inductor constructed in accordance with various embodiments of the invention.

FIG. 3 is a schematic diagram illustrating an equivalent circuit of a transformer of the tunable inductor of FIGS. 1 and 2.

FIG. 4 is a schematic diagram illustrating an equivalent capacitive component X that is the combination of the secondary coil with the capacitor of the tunable inductor of FIGS. 1 and 2 when the switch is in on state.

FIG. 5 is a schematic diagram illustrating an equivalent inductive component LM that is the coupling inductor Lm in parallel with the capacitive component X of the tunable inductor of FIGS. 1 and 2.

FIG. 6 is a schematic diagram illustrating an equivalent circuit of the effective inductance Leff of the tunable inductor of FIGS. 1 and 2.

FIG. 7 is a drawing illustrating a tunable inductor constructed in accordance with other various embodiments of the invention showing additional coupling capacitors.

FIG. 8 is a drawing illustrating a tunable inductor constructed in accordance with other various embodiments of the invention showing additional coupling capacitors.

FIG. 9 is a block diagram of a phase locked loop (PLL) including a voltage controlled oscillator (VCO) controlled by a tunable transformer with switched inductance constructed in accordance with various embodiments of the invention.

FIG. 10 is a schematic diagram illustrating a dual-band VCO constructed in accordance with various embodiments of the invention.

FIG. 11 is a graph of output frequency of the dual-band VCO of FIG. 10 showing dual-band operation over a tuning voltage range.

### DETAILED DESCRIPTION OF THE INVENTION

For simplicity and ease of explanation, the invention will be described herein in connection with various embodiments thereof. Those skilled in the art will recognize, however, that the features and advantages of the various embodiments may be implemented in a variety of configurations. It is to be understood, therefore, that the embodiments described herein are presented by way of illustration, not of limitation.

As used herein, an element or step recited in the singular and proceeded with the word “a” or “an” should be understood as not excluding plural said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. Additionally, the arrangement and configuration of the various components described herein may be modified or change, for example, replacing certain components with other components or changing the order or relative positions of the components.

Various embodiments of the present invention provide a tunable inductance arrangement having a tunable transformer wherein the mutual inductance to a second inductor (e.g., secondary winding) of the transformer is controlled using one or more switches on the second inductor of the transformer. The one or more switches switch the second inductor in and out of the transformer along with one or more capacitors connected to the secondary winding of the transformer.

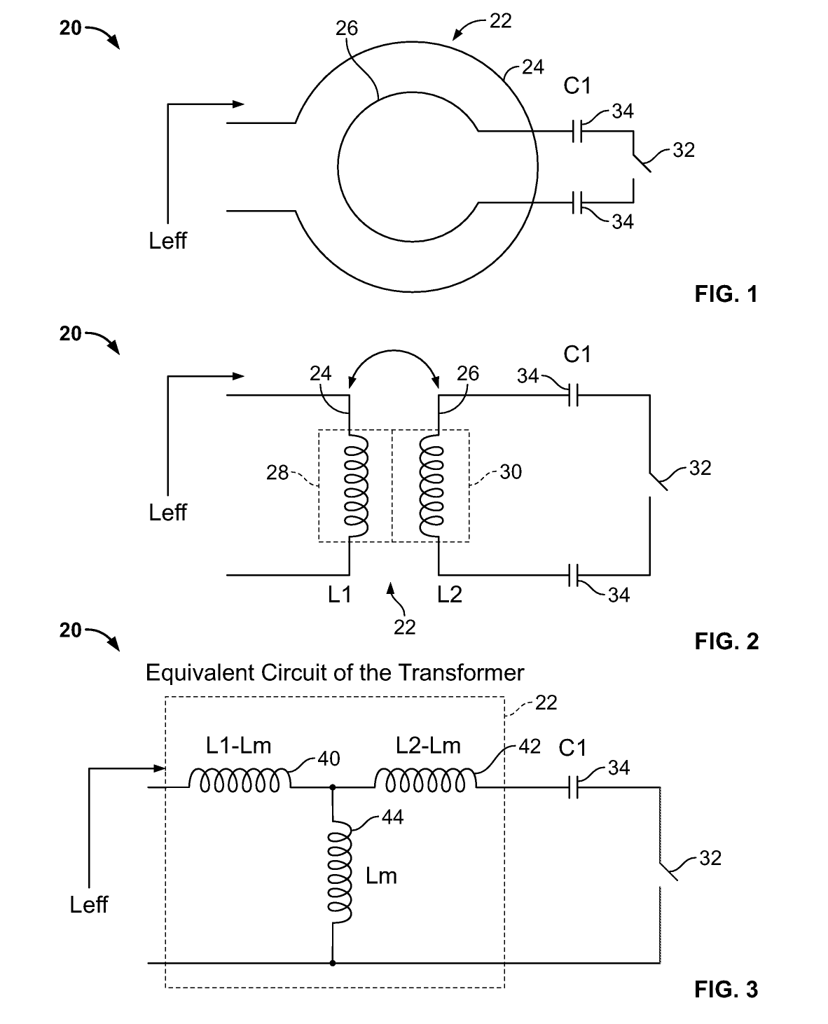

Specifically, and as shown in FIGS. 1 and 2, a tunable inductor 20 is provided, which in various embodiments includes a transformer 22, having a primary winding 24 and a secondary winding 26 that may define first and second poles of the transformer 22. The primary winding 24 defines a first inductor (L1) 28 and the secondary winding 26 defines a second inductor (L2) 30. It should be noted that the transformer 22 may be any type of device that transfers electrical energy from one circuit to another through inductively coupled electrical conductors. For example, the coupled inductors may be the first and second windings 24 and 26 and can be formed of different materials and using different processes. For example, the first and second windings 24 and 26 may be separate metal coil structures or metal deposits on a substrate having a monolithic implementation. In particular, when forming the first and second windings 24 and 26 as passive components, for example, as passive inductors formed on a substrate, the inductors may be formed by metal deposition in a spiral arrangement. The metal forming the inductors may be any suitable metal, for example, gold or a titanium platinum gold (TiPtAu) composite that is deposited on a top surface of the substrate. It should be noted that different shapes and sizes of the first and second windings 24 and 26 may be provided as desired or needed. Other configurations of inductors are also contemplated, for example, instead of metal spiral deposits, a helical multi-layer structure or any other suitable configuration as is known may be provided.

Referring again to FIGS. 1 and 2, a switch 32 together with one or more capacitors 34 (illustrated as coupling capacitors C1) are connected between ends of the secondary winding 26. It should be noted that the switch 32 may be any type of switching structure, for example, a solid state device such as a switching transistor (e.g., an N-type field-effect transistor (NFET)) or a micro electro-mechanical switch (MEMS). The switch 32 is configured to provide switching operation, for example, switching to form either an open or closed loop for the secondary winding 26 depending on a state or position of the switch 32. The one or more capacitors 34 are connected to the secondary winding 26. For example, a capacitor 34 may be connected between each end of the switch 32 and the secondary winding 26. It should be noted that the number and arrangement (e.g., series or parallel arrangement) of the capacitors 34 may be modified as desired or needed, for example, based on the operating parameters or desired characteristics of the tunable inductor 20.

In operation, the mutual inductance to the secondary winding 26 is controlled using the switch 32 connected to the secondary winding 26. In particular, when the switch 32 is in an off state such that an open loop arrangement is provided for the secondary winding 26, there is no induced current on the secondary inductor 30 and the effective inductance (Leff) of the tunable inductor 20 is primarily the inductance from the primary inductor 28. When the switch 32 is in an on state such that a closed loop arrangement is provided for the secondary winding 26, current is induced or flowing through the secondary inductor 30 due to the induced magnetic field and results in a mutual inductance Lmu between the first and second inductors 28 and 30. Accordingly, current flowing through the primary and secondary windings 24 and 26 provides an effective mutual inductance Lmu therebetween (i.e., between the first and second inductors 28 and 30). Thus, the Leff becomes and is defined as follows:

Leff=L1+Lmu Equation 1
Where Lmu=−Lm+Lm//X
   It should be noted that the magnitude of the effective mutual inductance (Lmu) can be varied by varying the values of one or more of the capacitors 34. Also, it should be noted that Lm//X means that Lm is in parallel connection with X.

Thus, when the switch 32 is in an off state, an open-circuit results in the secondary winding 26 wherein the effective inductance is defined as follows, which is the primary coil self-inductance:

Leff=(L1−Lm)+Lm=L1 Equation 2

When the switch is in an on state, a short circuit results in the secondary winding 26. The equivalent circuit for the transformer 22 is shown in FIG. 3 and represented as a T-network wherein the inductance of the primary winding 24 is represented by the inductor 40 having a value of L1−Lm, the inductance of the secondary winding 26 is represented by the inductor 42 having a value of L2−Lm and the mutual inductance resulting from the coupling effect of the transformer 22 is represented by the inductor 44 having a value of Lm. Because of the presence of the coupling capacitors, namely the capacitors 34, the mutual inductance (Lm) is in parallel connection with a combination of (L2−Lm)+C1 when the switch 32 is in an on state.

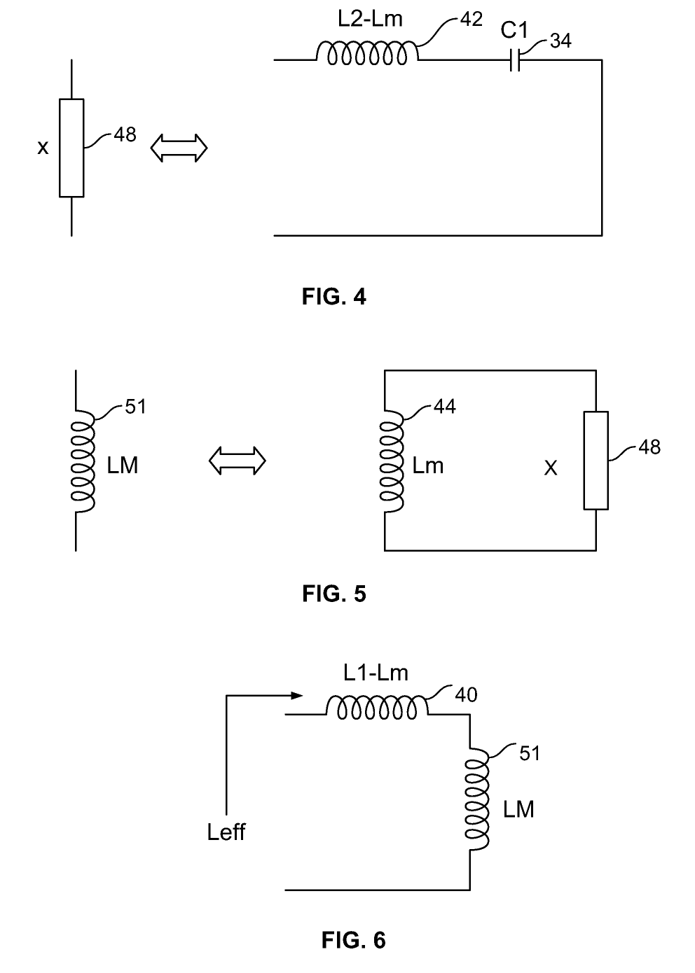

Referring now to FIGS. 4 through 6 showing a step by step illustration of the equivalent circuits for portions of the overall equivalent circuit for the transformer 22, C1 is selected such that the combination (L2−Lm)+C1 is capacitive, which is represented by the capacitive component (X) 48 shown in FIG. 4. Therefore, Lm in parallel with capacitive component (X) 48 results in an effective inductance LM represented by the inductive component 51 in FIG. 5, where LM>Lm. Accordingly, the effective inductance is defined as follows and as shown in FIG. 6:

Leff=(L1−Lm)+LM>L1 Equation 3

Therefore, when the switch 32 is in the on state, the resultant inductance, Leff, is larger than L1. Thus, in operation, the coupling capacitor (C1) 34 allows the various embodiments to achieve an inductance larger than L1.

In operation, with a larger L, when a typical switch is in the on state, the switch introduces some extra loss due to the use of the switch. This loss will generally degrade the quality factor of the inductor. The quality factor of the inductor can be estimated as Q=jwL/R, if the inductor is treated as a lossless inductor L with a series resistor R. Therefore, turning on the switch will increase R, and if at the same time, L becomes smaller, which is the case when there is no capacitor used, then the Q is reduced. However, in the various embodiments, when turning on the switch 32, the L increases, and R increases a little, but the Q of the inductor can remain relatively constant.

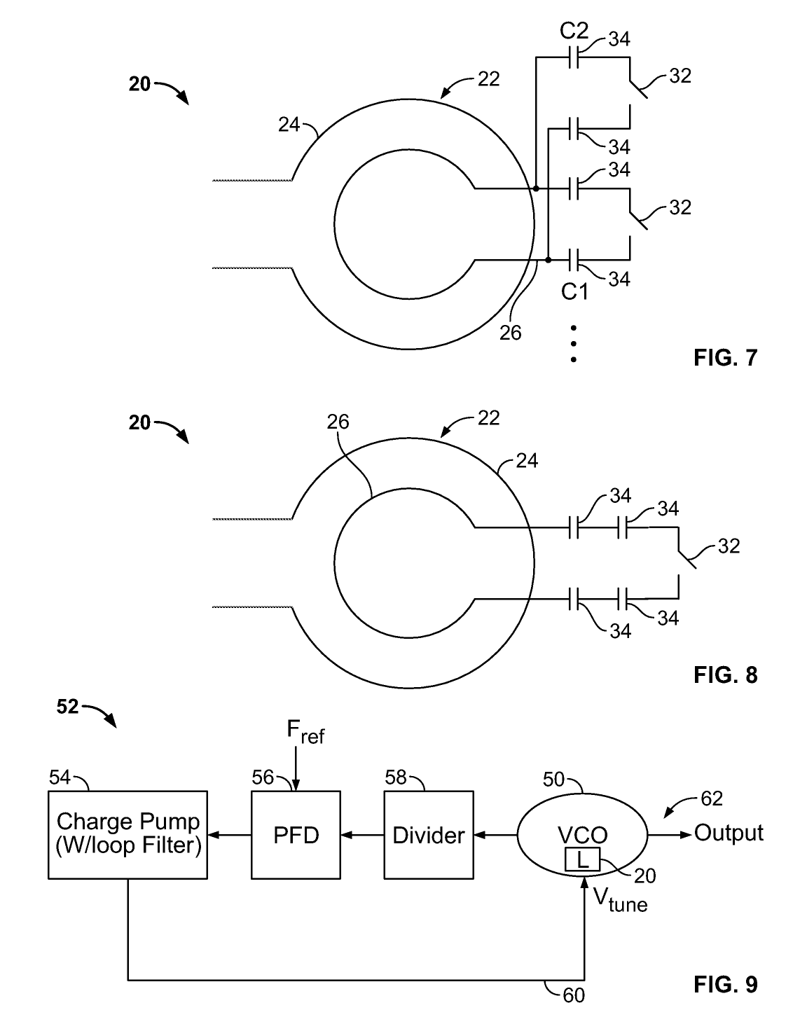

It should be noted that the tunable inductor 20 also may be modified to allow the inductance to be varied in different increments, for example, by changing the number of capacitors 34 and corresponding switches 32 as shown in FIG. 7. In particular, multiple pairs of capacitors 34 each with a corresponding switch 32 may be connected to the ends of the secondary winding 26. The number of capacitors 34 and switches also can be varied. For example, more than two capacitors 34 may be connected to the secondary winding 26 through a switch 32 as illustrated in FIG. 8 wherein two sets of two capacitors 34 (connected in series) are connected to the secondary winding 26. Also, multiple capacitors 34 may be connected in parallel or in series with respect to each switch 32 or with respect to the secondary winding 26. The addition of capacitors 34 allows the inductance to be varied in different combinations and steps, for example, in smaller incremental steps or larger incremental steps without reducing or greatly varying the quality factor (Q factor) of the tunable inductor 20. Also, the capacitors 34 may be variable capacitors.

The various embodiments of a tunable inductor 20 may form part of a voltage controller oscillator (VCO) 50 as shown in FIG. 9. In particular, the VCO 50 having the tunable inductor 20 may form part of a phase locked loop (PLL) 52. The PLL 52 includes a charge pump 54, the input of which is connected to the output of a phase frequency detector (PFD) 56. The input of the PFD 56 is connected to the output of a frequency divider 58. The input of the frequency divider 58 is connected to the VCO 50. A loop 60 is also provided from the output of the charge pump 54 to the control input of the VCO 50.

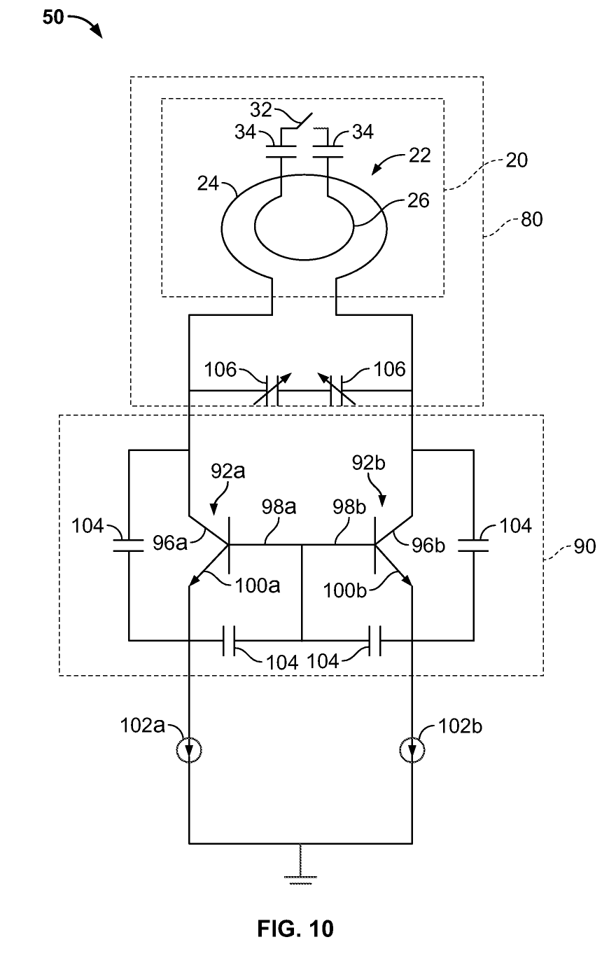

The VCO 50 is shown in more detail in FIG. 10, which is illustrated as a dual-band VCO with the tunable inductor 20 forming part of, for example, an on-chip resonator 80 that is connected to a VCO core 90. Each end of the primary winding 24 of the transformer 22 is connected to a transistor 92a and 92b, respectively of the VCO core 90. More particularly, each end of the primary winding 24 is connected to a collector 96a and 96b, respectively, of the transistors 92a and 92b. A base 98a and 98b of each of the transistors 92a and 92b is connected together. An emitter 100a and 100b of each of the transistors 92a and 92b is connected to ground through a current source 102a and 102b, respectively. The VCO core 90 also includes four capacitors 104, two each connected between the collectors 96a and 96b and the bases 98a and 98b of the transistors 92a and 92b, respectively. Additionally, a pair or variable capacitors 106 form part of the on-chip resonator 80 and are connected in parallel between the ends of the primary winding 24 and the collectors 96a and 96b of the transistors 92a and 92b of the VCO core 90.

It should be noted that although the VCO 50 is described in connection with the PLL 52 shown in FIG. 9, the VCO 50 may be provided in connection with different PLLs having different components parts or in different devices, for example, in a filter application. The VCO 50 also may be used in different applications having different operating requirements. For example, the VCO 50 may be used as part of a PLL in radio, telecommunications, computers and other electronic applications to generate stable frequencies (e.g., a frequency synthesizer) or to recover a signal from a noisy communication channel. The PLL 52 may be implemented in hardware, for example, a single integrated circuit chip, in software, or in combination thereof.

Referring again to FIG. 9, in operation, and merely for illustration, the phase of the VCO 50 at an output 62 is locked using the PLL 52 and based on an input signal, for example, an input frequency signal (Fref) received at the PFD 56. The PLL 52 is essentially an electronic control system that generates a signal that is locked to the phase of the input or reference signal. The PLL 52 responds to both the frequency and the phase of the input signal and automatically increases or decreases the frequency of the VCO 50 until the output frequency of the VCO 50 is matched to the reference signal (times a divider ratio) in both frequency and phase (which may include an acceptable deviation). It should be noted that the VCO 50 generates a periodic output signal and the charge pump 54 sends a control signal to the VCO 50 based on feedback from the loop 60. For example, if initially the VCO 50 is at about the same frequency as the reference signal (times the divider ratio), then if the phase from the VCO 50 falls behind, the control voltage of the charge pump 54 is changed based on the change in frequency as detected by the PFD 56. The frequency of the VCO 50 is accordingly increased (e.g., oscillation speeds up). If the phase moves ahead, the control voltage is again changed, but to decrease the frequency of the VCO 50 (e.g., oscillation slows down).

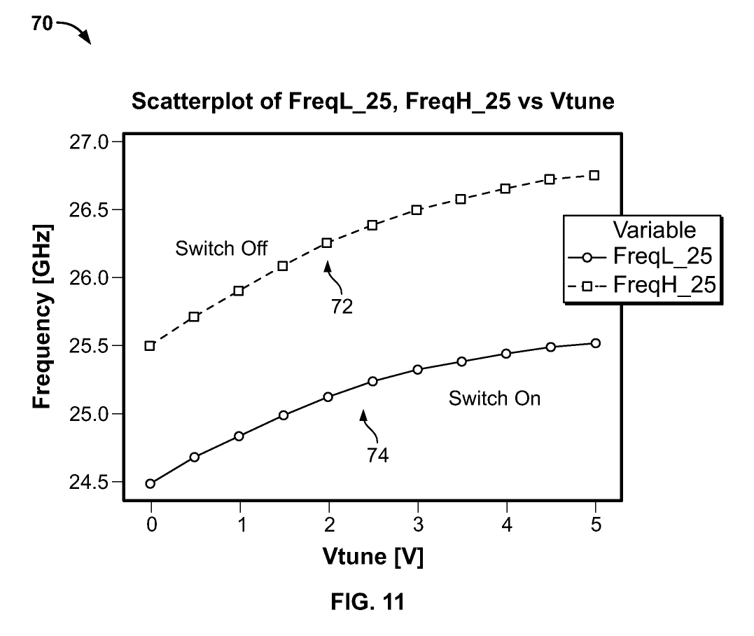

In a dual-band VCO design as shown in FIG. 10, the various embodiments provide a frequency output as shown in the graph 70 of FIG. 11 wherein switching is provided between two different opening frequencies, illustrated as a high operating frequency (FreqH_25) and a low operating frequency (FreqL_25). It should be noted that the high operating frequency results when the switch 32 is in an off state and the low operating frequency results when the switch is in an on state.

The layout of the transformer 22 allows the tunable inductor 20 to be formed in a compact footprint, for example, having the dimensions of a typical on-chip inductor. Moreover, requirements on the loss of the switch 32 can be relatively reduced as the switch 32 only affects the tunable inductor 20 through the capacitors 34 and the coupling of the transformer 22. The various embodiments also allow greater flexibility in the design of the tunable inductor 20 in that the self-inductance of L2, the coupling coefficient of the transformer 22, the capacitance of the capacitors 34 (coupling capacitors) and the sizes of the switches 32 can be more easily varied for specific applications.

It should be noted that modifications and variations to the various embodiments are contemplated. For example, the number, relative positioning and operating parameters of the various components may be modified based on the particular application, use, etc. The modification may be based on, for example, different desired or required operating characteristics.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112, sixth paragraph, unless and until such claim limitations expressly use the phrase “means for” followed by a statement of function void of further structure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A tunable inductor comprising:
a transformer having a primary winding and a secondary winding;
a switch connected to the secondary winding of the transformer; and
at least one capacitor connected to the secondary winding of the transformer with the switch.

2. A tunable inductor in accordance with claim 1 wherein the at least one capacitor comprises a pair of capacitors connected in parallel across the secondary winding of the transformer.

3. A tunable inductor in accordance with claim 2 further comprising a plurality of switches and wherein each pair of capacitors is connected to the secondary winding of the transformer through a different one of the plurality of switches.

4. A tunable inductor in accordance with claim 2 wherein in each pair of capacitors has a different capacitive value.

5. A tunable inductor in accordance with claim 1 wherein the at least one capacitor comprises a variable capacitor.

6. A tunable inductor in accordance with claim 1 wherein the switch comprises at least one of a solid state switch and a micro electro-mechanical switch.

7. A tunable inductor in accordance with claim 1 further comprising at least one capacitor connected to each end of the secondary winding of the transformer.

8. A tunable inductor in accordance with claim 1 wherein the primary and secondary windings define first and second inductors.

9. A tunable inductor in accordance with claim 1 wherein the switch is operable between an on state wherein the at least one capacitor is connected to the secondary winding of the transformer and an off state wherein the at least one capacitor is not connected to the secondary winding of the transformer.

10. A tunable inductor in accordance with claim 1 wherein the switch is operable between an on state providing a short connection to the secondary winding of the transformer and an off state providing an open connection to the secondary winding of the transformer.

11. A tunable inductor in accordance with claim 1 wherein the primary and secondary windings comprise passive inductors.

12. A tunable inductor in accordance with claim 1 wherein the primary and secondary windings comprise primary and secondary coils.

13. A tunable inductor in accordance with claim 1 wherein the primary winding is connected to a voltage controlled oscillator (VCO).

14. A tunable inductor in accordance with claim 13 wherein the VCO operates in at least two frequency bands.

15. A tunable transformer comprising:
a primary coil having a primary self-inductance L1; and
a secondary coil having a secondary self-inductance L2, and wherein an effective inductance is defined by the inductance on the primary coil with the secondary coil loaded with the combination of a capacitor and a switch.

16. A tunable transformer is accordance with claim 15 wherein a value of the capacitor results in an effective inductance being greater than a mutual inductance.

17. A tunable transformer is accordance with claim 15 wherein in an off state of the switch the effective inductance is defined by L1.

18. A tunable transformer is accordance with claim 15 wherein in an on state of the switch the effective inductance is larger than L1.

19. A method of tuning a transformer using capacitive loading, the method comprising:
connecting at least one capacitor to a secondary winding of the transformer; and
providing a switch to connect and disconnect the at least one capacitor from the secondary winding of the transformer to provide a switched inductance.

20. A method in accordance with claim 19 further comprising connecting a pair of capacitors to ends of the secondary winding of the transformer.
